(19) United States
(12) Patent Application Publication
(10) Pub. No.: US 2018/0294459 A1
(43) Pub. Date: Oct. 11, 2018

(54) LAMINATED POROUS FILM, SEPARATOR FOR NON-AQUEOUS ELECTROLYTE SECONDARY CELL, NON-AQUEOUS ELECTROLYTE SECONDARY CELL, AND PRODUCTION METHOD FOR LAMINATED POROUS FILM

(71) Applicant: Mitsubish Chemical Corporation, Chiyoda-ku, Tokyo (JP)

(72) Inventors: Hiroto YAMADA, Ogaki-shi (JP); Masayuki SEO, Nagahama-shi (JP); Tomoyuki NEMOTO, Nagahama-shi (JP)

(21) Appl. No.: 15/743,796

(22) PCT Filed: Jul. 12, 2016
(86) PCT No.: PCT/JP2016/070546

§ 371 Date: Jun. 13, 2018

(30) Foreign Application Priority Data
Jul. 15, 2015 (JP) 2015-141634

(51) Int. Cl. H01M 2/16; H01M 2/14

(52) U.S. Cl. CPC H01M 2/1686; H01M 2/145; H01M 2/166; H01M 2/1653

(57) ABSTRACT

To provide a laminated porous film that has SD characteristics, is excellent in handleability and safety due to the small curl thereof in the case where a porous coating layer is provided asymmetrically on front and back surfaces, and has heat resistance and gas permeability, and thus the laminated porous film can be favorably used as a separator for a non-aqueous electrolyte secondary cell. The laminated porous film contains a polyolefin resin porous film having a structure where porous layers A each containing a polyolefin resin having a melting point of 150° C. or more as a major component and a porous layer B containing a polyolefin resin as a major component and undergoing pore closure in a temperature range of 100° C. or more and less than 150° C. are laminated in an order of A/B/A and having a width shrinkage of 0.1% or more and 3% or less in a heat treatment at a temperature of 130° C. for 1 hour, and having, laminated and provided on at least one surface of the polyolefin resin porous film so as to be asymmetrically on front and back surfaces, the porous coating layer containing inorganic particles and a binder resin composition, the laminated porous film having a maximum curl height in a width direction of 5 mm or less.

### TECHNICAL FIELD

The present invention relates to a laminated porous film used in packaging, sanitary, animal husbandry, agricultural, architectural, and medical applications, separator membranes, light diffusing plates, and separators for a battery cell. The present invention also relates to a separator for a non-aqueous electrolyte secondary cell and a non-aqueous electrolyte secondary cell both using the laminated porous film.

### BACKGROUND ART

A porous polymer material having many open micropores is used in various fields, such as a separator membrane used in ultrapure water production, purification of chemical solutions, and water treatment, a waterproof moisture-permeable film used in clothing and sanitary supplies, and a separator used in secondary cells.

A secondary cell is widely used as a power supply for portable instruments, such as OA, FA, electric appliances for home use, and communication appliances. In particular, a portable instrument using a lithium ion secondary cell is becoming widespread since the lithium ion secondary cell mounted on the instruments has a high volumetric efficiency and therefore can reduce the size and the weight of the instruments. A large-size secondary cell is under research and development in many fields relating to energy and environmental issues, including load-leveling, UPS, and electric vehicles, and the applications of a lithium ion secondary cell, which is one type of a non-aqueous electrolyte secondary cell, are becoming widespread due to the large capacity, the high output power, the high voltage, and the excellent long-term storage stability thereof.

A lithium ion secondary cell is generally so designed as to have a highest working voltage falling in a range of from 4.1 to 4.2 V. An aqueous solution is electrolyzed at such a high voltage and could not be used as an electrolyte. Consequently, a so-called non-aqueous electrolyte, which contains an organic solvent, is used as an electrolyte that can withstand the high voltage. A high-permittivity organic solvent, which can dissolve a larger amount of lithium ions, is used as a solvent for the non-aqueous electrolyte. An organic carbonate compound, such as propylene carbonate and ethylene carbonate, is mainly used as the high-permittivity organic solvent. A highly-reactive electrolyte, such as lithium hexafluorophosphate, is dissolved in the solvent and is used as a supporting electrolyte to serve as a lithium ion source in the solvent.

A lithium ion secondary cell has a separator arranged between a positive electrode and a negative electrode in order to prevent internal short-circuit. The separator is naturally required to have insulating property due to the function thereof. In addition, the separator necessarily has a microporous structure in order to achieve permeability for passage of lithium ions therethrough and to diffuse and retain the electrolyte therein. A porous film is used as the separator for satisfying these requirements.

The recent tendency toward a rise in cell capacity has resulted in the increase in the importance in cell safety. The characteristics of separators for a battery cell that contribute to the safety include shutdown characteristics (hereinafter referred to as a “SD characteristics”). The SD characteristics include such a function that micropores of a porous film are closed at a high temperature in a range of approximately from 100 to 150° C., and thereby ionic conduction in a battery cell is intercepted, and a subsequent temperature rise in the battery cell can be prevented. The lowest temperature, at which micropores of a porous film are closed, is referred to as a shutdown temperature (hereinafter referred to as a “SD temperature”). A porous film to be used as a separator for a battery cell necessarily has the SD characteristics.

However, due to the tendency of increase of the energy density and the capacity of a lithium ion secondary cell in recent years, the cell having high energy may cause such an accident that even though the progress of the electrochemical reaction is terminated by the shutdown, the temperature inside the cell is continuously increased beyond approximately 130° C., which is the melting point of polyethylene used as an ordinary separator for a battery cell, and the electrodes are short-circuited by the breakage of the separator due to the thermal shrinkage thereof, resulting in ignition. Under the circumstances, for ensuring the safety, the separator is demanded to have higher heat resistance than for the SD characteristics at the present time.

In response to the demand, a laminated porous film containing an olefin porous film having provided on at least one surface thereof a porous coating layer has been proposed (see PTLs 1 to 5).

The literatures describe that the porous coating layer having fine particles highly filled therein is provided on the porous film, and thereby even in the case where the temperature is continuously increased beyond the SD temperature due to the abnormal heat generation, the electrodes can be prevented from being short-circuited, thus providing a method having excellent safety.

### CITATION LIST

### Patent Literature

PTL 1: JP 2004-227972 A

PTL 2: JP 2008-186721 A

PTL 3: WO 2008/149986

PTL 4: JP 2008-305783 A

PTL 5: WO 2012/023199

PTL 6: WO 2014/002701

### SUMMARY OF INVENTION

### Technical Problem

However, in the case where the porous coating layer is provided on either one of one surface and the other surface (which may be hereinafter referred to as “front surface and back surface” respectively) of the porous film, and in the case where the porous coating layers are provided on the front surface and the back surface of the porous film with different thicknesses respectively (both the cases are hereinafter referred to as “provided asymmetrically on front and back surfaces”), the resulting laminated porous film tends to curl in the width direction thereof. As a result, the laminated porous film causes inconveniences including folding wrinkles and fluttering in the case where the film is wound into a roll product and in the case where the film is wound with an electrode into a wound assembly for using the film as a separator for a cylindrical battery cell.

In the description herein, the “running direction” of the film means the conveying direction of the film in the production of the film (i.e., the so-called MD), and the “width direction” of the film means the direction that is perpendicular to the running direction and is substantially in parallel to the floor surface (i.e., the so-called TD).

As for the technique for suppressing the curl in the width direction of the laminated porous film (which may be hereinafter referred to as a curl resistance), the present inventors describe a technique of controlling the circularity of the inorganic particles in the porous coating layer laminated on the porous film to a particular range (see PTL 6).

However, all PTLs 1 to 6 still cannot achieve a laminated porous film that is excellent in all curl resistance, heat resistance, gas permeability, and SD characteristics.

An object of the present invention is to provide a laminated porous film that is excellent in all curl resistance, heat resistance, gas permeability, and SD characteristics.

### Solution to Problem

As a result of earnest investigations by the present inventors, it has been found that the problem can be solved by a laminated porous film containing a polyolefin resin porous film having a particular structure and a thermal shrinkage in a width direction in a particular range, and having, on at least one surface thereof so as to be provided asymmetrically on front and back surfaces, a porous coating layer containing inorganic particles and a binder resin composition, and thus the present invention has been completed.

The present invention is as follows.

[1] A laminated porous film containing a polyolefin resin porous film having a structure where porous layers A each containing a polyolefin resin having a melting point of 150° C. or more as a major component and a porous layer B containing a polyolefin resin as a major component and undergoing pore closure in a temperature range of 100° C. or more and less than 150° C. are laminated in an order of A/B/A, and having, laminated on at least one surface of the polyolefin resin porous film, a porous coating layer containing inorganic particles and a binder resin composition, the porous coating layer being provided asymmetrically on front and back surfaces of the polyolefin resin porous film, the polyolefin resin porous film having a width shrinkage of 0.1% or more and 3% or less in a heat treatment at a temperature of 130° C. for 1 hour, a maximum curl height in a width direction of the laminated porous film being 5 mm or less on standing the laminated porous film having a size of 15 cm square still on a stainless steel (SUS) plate under an atmosphere of a temperature of 25° C. and a relative humidity of 50% for 5 minutes.

[2] The laminated porous film according to the item [1], wherein a ratio T_{d}/T_{PO} of an absolute value (T_{d}) of a difference in average thickness between the porous coating layers on the front and back surfaces of the polyolefin resin porous film to a thickness (T_{PO}) of the polyolefin resin porous film is 0.1 or more and 0.5 or less.

[3] The laminated porous film according to the item [1] or [2], wherein the porous layer A contains a polypropylene resin as a major component.

[4] The laminated porous film according to any one of the items [1] to [3], wherein the porous layer B contains a polyethylene resin as a major component.

[5] The laminated porous film according to any one of the items [1] to [4], wherein the polyolefin resin porous film has a porosity of 30% or more and 50% or less.

[6] The laminated porous film according to any one of the items [1] to [5], wherein the binder resin composition has an equilibrium water content of 1% or more.

[7] The laminated porous film according to any one of the items [1] to [6], which has a melt in-plane shrinkage of 8% or less.

[8] A separator for a non-aqueous electrolyte secondary cell, containing the laminated porous film according to any one of the items [1] to [7].

[9] A non-aqueous electrolyte secondary cell containing the separator for a non-aqueous electrolyte secondary cell according to the item [8].

[10] A method for producing a laminated porous film, including: applying a tension in a width direction to a polyolefin resin porous film which has a structure where porous layers A each containing a polyolefin resin having a melting point of 150° C. or more as a major component and a porous layer B containing a polyolefin resin as a major component and undergoing pore closure in a temperature range of 100° C. or more and less than 150° C. are in a structure of A/B/A and has a width shrinkage of less than 0.1% in a heat treatment at a temperature of 130° C. for 1 hour, so as to have a width shrinkage of 0.1% or more and 3% or less in a heat treatment at a temperature of 130° C. for 1 hour, and then forming a porous coating layer containing inorganic particles and a binder resin composition on at least one surface of the polyolefin resin porous film.

### Advantageous Effects of Invention

The laminated porous film of the present invention has SD characteristics, is excellent in handleability and safety due to the small curl thereof in the case where the porous coating layer is provided asymmetrically on front and back surfaces, and has heat resistance and gas permeability, and thus the laminated porous film can be favorably used as a separator for a non-aqueous electrolyte secondary cell.

### BRIEF DESCRIPTION OF DRAWINGS

FIG. 1 is a schematic cross sectional view of a battery cell containing the laminated porous film of the present invention.

FIG. 2 is an illustration describing a measurement method for a peeling strength.

FIG. 3 is an illustration describing a measurement method for SD characteristics.

### DESCRIPTION OF EMBODIMENTS

Embodiments of the laminated porous film of the present invention will be described in detail below.

In the present invention, the expression “major component” encompasses that any other component may be contained in such a range that does not impair the function of the major component, unless otherwise indicated, and encompasses that the major component has the largest content ratio in the composition and preferably has a content ratio of 50% by mass or more, more preferably 70% by mass or more, and particularly preferably 90% by mass or more (including 100%).

The expression “from X to Y” (wherein X and Y each show an arbitrary numeral) encompasses “X or more and Y or less” and also encompasses “preferably more than X” and “preferably less than Y”, unless otherwise indicated.

### [Laminated Porous Film]

The laminated porous film of the present invention has a structure containing a polyolefin resin porous film having laminated thereon a porous coating layer.

The polyolefin resin porous film and the porous coating layer constituting the laminated porous film of the present invention will be described in detail below.

### <Polyolefin Resin Porous Film>

It is important that the polyolefin resin porous film used in the present invention has a structure where porous layers each A containing a polyolefin resin having a melting point of 150° C. or more as a major component and a porous layer B containing a polyolefin resin as a major component and undergoing pore closure in a temperature range of 100° C. or more and less than 150° C. are in a structure with an order of A/B/A.

In the polyolefin resin porous film, the porous layer A has a function retaining heat resistance (shape retentivity). The porous layer B undergoes pore closure in a temperature range of 100° C. or more and less than 150° C., so as to exhibit SD characteristics in the case where the laminated porous film of the present invention is used as a separator for a battery cell, providing a function enhancing the safety.

### (Porous Layer A)

The polyolefin resin used in the porous layer A is not particularly limited, as far as the resin has a melting point of 150° C. or more, and examples thereof include a homopolymer and a copolymer obtained through polymerization of an α-olefin, such as 4-methyl-1-pentene. Two or more kinds of the homopolymer or the copolymer may be mixed. Among these, a polypropylene resin is preferably contained as a major component from the standpoint of the easiness in formation of pores, the excellent productivity of the polyolefin resin porous film, and the retention of the gas permeability and the mechanical strength of the laminated porous film of the present invention.

The melting point of the polyolefin resin is a melt peak temperature obtained by differential scanning calorimetry (DSC) according to JIS K7121 (2012).

### (Polypropylene Resin)

Examples of the polypropylene resin used in the present invention include a homopolypropylene (i.e., a propylene homopolymer) and a random copolymer and a block copolymer of propylene with an α-olefin, such as ethylene, 1-butene, 1-pentene, 1-hexene, 1-heptene, 1-octene, 1-nonene, and 1-decene. Among those, a homopolypropylene is more preferably used from the standpoint of retaining the mechanical strength, the heat resistance, and the like of the laminated porous film of the present invention.

The polypropylene resin used preferably has an isotactic pentad fraction (mmmm fraction), which indicates the stereoregularity thereof, of from 80 to 99%, more preferably from 83 to 98%, and further preferably from 85 to 97%. When the isotactic pentad fraction is the lower limit or more, the mechanical strength of the film may be enhanced. While the upper limit of the isotactic pentad fraction is defined as the upper limit that is industrially available at the present time, the upper limit may not be applied to the case where a resin having a further higher regularity is industrially developed in future.

The isotactic pentad fraction (mmmm fraction) means a steric structure having a main chain of carbon-carbon bonds formed of arbitrary continuous five propylene units with the five side chains of methyl groups that are all positioned in the same direction with respect to the main chain, or the proportion of the structure.

The isotactic pentad fraction (mmmm fraction) may be calculated based on a measurement result of ¹³C-NMR, and the signals in the methyl group region are assigned according to A. Zambelli et al. (Macromolecules 8, 687, (1975)).

The ratio Mw/Mn of the polypropylene resin, which is the ratio of the number average molecular weight (Mn) and the weight average molecular weight (Mw) and is the parameter showing the molecular weight distribution thereof, is preferably from 2.0 to 10.0, more preferably from 2.0 to 8.0, and further preferably from 2.0 to 6.0. A smaller ratio Mw/Mn means a narrower molecular weight distribution, and when the value Mw/Mn is in the range, the extrusion moldability may be enhanced, and the mechanical strength of the laminated porous film may also be enhanced.

The ratio Mw/Mn of the polypropylene resin may be measured by a GPC (gel permeation chromatography) method.

The density of the polypropylene resin is preferably from 0.890 to 0.970 g/cm³, more preferably from 0.895 to 0.970 g/cm³, and further preferably from 0.900 to 0.970 g/cm³. When the density is 0.890 g/cm³ or more, appropriate SD characteristics may be obtained. When the density is 0.970 g/cm³ or less, appropriate SD characteristics may be obtained, and in addition, the stretchability may be retained.

The density of the polypropylene resin may be measured by the density gradient tube method according to JIS K7112 (1999).

The melt flow rate (MFR) of the polypropylene resin is not particularly limited, and is preferably from 0.5 to 15 g/10 min, more preferably from 1.0 to 10 g/10 min, further preferably from 1.5 to 8.0 g/10 min, and particularly preferably from 2.0 to 6.0 g/10 min. When the MFR is 0.5 g/10 min or more, the melt viscosity of the resin in molding can be increased to ensure sufficient productivity. When the MFR is 15 g/110 min or less, the mechanical strength of the resulting laminated porous film can be sufficiently retained.

The MFR of the polypropylene resin may be measured under the condition of a temperature of 230° C. and a load of 2.16 kg according to JIS K7210 (1999).

The production method used for the polypropylene resin is not particularly limited, and may be various known polymerization methods using known olefin polymerization catalysts, and examples thereof include a suspension polymerization method, a melt polymerization method, a bulk polymerization method, and a vapor-phase polymerization method using a multi-site catalyst represented by a Ziegler-Natta catalyst or using a single-site catalyst represented by a metallocene catalyst, and a bulk polymerization method using a radical initiator.

The polypropylene resin used may be commercially available products, and examples thereof include those under trade names including “Novatec PP” and “WINTEC (registered trade name)” (both produced by Japan Polypropylene Corporation), “Notio” and “Tafmer XR” (both produced by Mitsui Chemicals, Inc.), “Zelas (registered trade name)” and “Thermorun (registered trade name)” (both produced by Mitsubishi Chemical Corp.), “Sumitomo Noblen” and “Tafthren (registered trade name)” (both produced by Sumitomo Chemical Co., Ltd.), “Prime Polypro (registered trade name)” and “Prime TPO (registered trade name)” (both produced by Prime Polymer Co., Ltd.), “Adflex”, “Adsyl” and “HMS-PP (PF814)” (all produced by SunAllomer Ltd.), and “Versify (registered trade name)” and “Inspire” (both produced by The Dow Chemical Company).

### (Porous Layer B)

The porous layer B of the polyolefin resin porous film used in the present invention has a function of undergoing pore closure at 100° C. or more, and thereby has such a function that in the use of the laminated porous film of the present invention as a separator for a battery cell, the laminated porous film exhibits SD characteristics to ensure the safety, and can retain gas permeability, i.e., ion permeability, in a temperature range of less than 100° C. The porous layer B undergoes pore closure in a temperature range of less than 150° C., and thereby has such a function that the SD characteristics is immediately exhibited to shutdown the ion flow (i.e., the electric current) and to control the chemical reaction inside the battery cell, thereby preventing the thermal runaway.

The polyolefin resin used as a major component of the porous layer B is not particularly limited, as far as the resin undergoes pore closure in a temperature range of 100° C. or more and less than 150° C. In other words, a resin having a melting point of less than 100° C. or 150° C. or more may be used, as far as the porous layer B undergoes pore closure in a temperature range of 100° C. or more and less than 150° C.

Specific examples thereof include a homopolymer and a copolymer obtained through polymerization of an α-olefin, such as ethylene, propylene, and 1-butene. Two or more kinds of the homopolymer or the copolymer may be mixed. Among these, a polyethylene resin is preferably contained as a major component from the standpoint of the easiness in formation of pores, the excellent productivity of the polyolefin resin porous film, and the stable exhibition of the pore closure function in a temperature range of 100° C. or more and less than 150° C.

### (Polyethylene Resin)

Examples of the polyethylene resin used in the present invention include a low density polyethylene, a linear low density polyethylene, a linear ultralow density polyethylene, a medium density polyethylene, a high density polyethylene, and a copolymer containing ethylene as a major component.

Examples of the copolymer containing ethylene as a major component include a copolymer and a multicomponent copolymer of ethylene with one or more comonomer selected from an α-olefin having from 3 to 10 carbon atoms, such as propylene, 1-butene, 1-pentene, 1-hexene, 1-heptene, and 1-octene; a vinyl ester, such as vinyl acetate and vinyl propionate; an unsaturated carboxylic ester, such as methyl acrylate, ethyl acrylate, methyl methacrylate, and ethyl methacrylate; and a conjugated diene and a non-conjugated diene, and a mixed composition of the copolymer and the multicomponent copolymer. The ethylene polymer generally has a content of an ethylene unit exceeding 50% by mass.

Among those polyethylene resins, at least one polyethylene resin selected from a low density polyethylene, a linear low density polyethylene and a high density polyethylene is preferred, and a high density polyethylene is more preferred.

The density of the polyethylene resin is preferably from 0.910 to 0.970 g/cm³, more preferably from 0.930 to 0.970 g/cm³, and further preferably from 0.940 to 0.970 g/cm³. When the density is 0.910 g/cm³ or more, appropriate SD characteristics may be obtained. When the density is 0.970 g/cm³ or less, appropriate SD characteristics may be obtained, and in addition, the stretchability may be retained.

The density of the polyethylene resin may be measured by the density gradient tube method according to JIS K7112 (1999).

The melt flow rate (MFR) of the polyethylene resin is not particularly limited, and is preferably from 0.03 to 30 g/10 min, and more preferably from 0.3 to 10 g/10 min. When the MFR is 0.03 g/10 min or more, the melt viscosity of the resin in molding can be sufficiently lowered to ensure sufficient productivity. When the MFR is 30 g/10 min or less, the mechanical strength can be sufficiently retained.

The MFR of the polyethylene resin may be measured under the condition of a temperature of 190° C. and a load of 2.16 kg according to JIS K7210 (1999).

The production method used for the polyethylene resin is not particularly limited, and may be various known polymerization methods using known olefin polymerization catalysts, and examples thereof include a polymerization method using a multi-site catalyst represented by a Ziegler-Natta catalyst or using a single-site catalyst represented by a metallocene catalyst. Examples of the polymerization method of the polyethylene resin include single stage polymerization, dual stage polymerization, and multistage polymerization with more than two stages, and a polyethylene resin obtained through polymerization by any of the polymerization methods may be used.

### (Additional Components)

In the present invention, additives that have been generally blended in resin compositions may be appropriately added to the porous layers A and the porous layer B of the polyolefin resin porous film in such a range that does not impair the effects of the present invention, in addition to the aforementioned resins. Examples of the additives include additives added for the purpose of improving and regulating the moldability, the productivity, and the various properties of the polyolefin resin porous film, for example, a recycled resin generated from the trimming loss of deckle edges and the like; inorganic particles, such as silica, talc, kaolin, and calcium carbonate; a pigment, such as carbon black; a flame retardant; a weather resistant stabilizer; a heat resistant stabilizer; an antistatic agent; a melt viscosity improver; a crosslinking agent; a lubricant; a nucleating agent; a plasticizer; an antiaging agent; an antioxidant; a light stabilizer, an ultraviolet ray absorbent; a neutralizing agent; an antifogging agent; an antiblocking agent; a slipping agent; and a colorant.

Various other resins, a low molecular weight compound, such as wax, and the like may also be added in such a range that does not impair the effects of the present invention, for promoting the pore opening and imparting the moldability.

### (Layer Structure of Polyolefin Resin Porous Film)

The polyolefin resin porous film in the present invention is not particularly limited as to the presence of an additional layer that does not impair the effects of the present invention, as far as the porous layers A and the porous layer B constitute the structure with the order A/B/A. Examples of the allowable structure include a four-layer structure of A/additional layer/B/A, a five-layer structure of other layer/A/B/A/other layer, and a five-layer structure of A/B/A/B/A. The number of layers may be increased, for example, to 6 layers or 7 layers depending on necessity.

Among these, a two-kind and three-layer structure of A/B/A is preferred from the standpoint of decreasing the thickness of the laminated porous structure of the present invention and the standpoint of the enhancement of the productivity of the polyolefin resin porous film.

The thickness ratio of the porous layers A and the porous layer B in the polyolefin resin porous film is preferably in a range of A/B/A=1/0.2/1 to 1/8/1. When the ratio is in the range, the functions of the porous layers A and the porous layer B exert a synergistic effect, and thereby SD characteristics can be exhibited while the heat resistance and the mechanical strength are retained.

### (Width Shrinkage of Polyolefin Resin Porous Film)

In the present invention, it is important that the polyolefin resin porous film used has a width shrinkage of 0.1% or more and 3% or less in a heat treatment at 130° C. for 1 hour. In the description herein, the “width shrinkage” means the thermal shrinkage of the polyolefin resin porous film in the width direction of the film.

When the width shrinkage of the polyolefin resin porous film in a heat treatment at 130° C. for 1 hour is 0.1% or more, the curl of the laminated porous film of the present invention can be suppressed even though the porous coating layer described later is provided asymmetrically on front and back surfaces. When the width shrinkage of the polyolefin resin porous film in a heat treatment at 130° C. for 1 hour is 3% or less, the shrinkage of the laminated porous film can be suppressed, and the risk of short circuit of the film installed in a non-aqueous electrolyte secondary cell can be reduced.

The lower limit of the width shrinkage of the polyolefin resin porous film in a heat treatment at 130° C. for 1 hour is more preferably 0.15% or more, and further preferably 0.2% or more, from the standpoint of the suppression of curl. The upper limit thereof is more preferably 2% or less, further preferably 1% or less, and particularly preferably 0.5% or less, from the standpoint of the suppression of shrinkage.

The width shrinkage of the polyolefin resin porous film in a heat treatment at 130° C. for 1 hour may be measured by the method described in the examples later.

The mechanism of the suppression of curl in the present invention will be described more specifically below.

In the case where the laminated porous film is produced by laminating the porous coating layer on the polyolefin resin porous film, by using the inorganic particles and the binder resin composition described later, the porous coating layer is shrunk through drying shrinkage of the binder resin.

In the case where the porous coating layer is provided asymmetrically on front and back surfaces, i.e., in the case where the porous coating layer is provided on either one of one surface and the other surface of the polyolefin resin porous film or in the case where the porous coating layers are provided on the front surface and the back surface of the polyolefin resin porous film with different thicknesses respectively, the laminated porous film is curled due to the shrinkage of the porous coating layer. This phenomenon is derived from the difference in shrinkage force between the polyolefin resin porous film and the porous coating layer and the difference in shrinkage force between the porous coating layers on both the surfaces.

In the case where the porous coating layer is provided asymmetrically on front and back surfaces of the polyolefin resin porous film by a coating and drying method described later, in particular, the curl tends occur in the process of transition from a high humidity atmosphere to a dry atmosphere. In addition, while the detailed mechanism is unclear, the occurrence of curl becomes conspicuous in the polyolefin resin porous film having the porous layers A and the porous layer B used in the present invention.

Under the circumstances, the present inventors have found that the shrinkage force of the porous coating layer and the shrinkage force of the polyolefin resin porous film are compensated by using the polyolefin resin porous film having the particular structure and the particular width shrinkage as the substrate, and thereby the curl of the laminated porous film having the porous coating layer provided asymmetrically on front and back surfaces can be reduced.

In the case where the polyolefin resin porous film is produced by the production method described later, the width shrinkage of the polyolefin resin porous film can be controlled to the aforementioned range, for example, by adjusting the inflation rate and the draft rate, and also the temperature and the stretch ratio on stretching.

In the case where a commercially available polyolefin resin porous film that has a width shrinkage of less than 0.1% in a heat treatment at a temperature of 130° C. for 1 hour is used, the width shrinkage can be controlled to the aforementioned range in such a manner that a tension is applied in the width direction of the film, so as to stretch the film slightly, by using a tenter, an expander roll, or the like.

At this time, the tension applied to the film per a cross sectional area of 1 mm² is preferably 0.5 N/mm² or more and 50 N/mm² or less, more preferably 1 N/mm² or more and 30 N/mm² or less, and further preferably 2 N/mm² or more and 20 N/mm² or less. When the tension applied is 0.5 N/mm² or more, a favorable width shrinkage can be imparted to the film, and when the tension is 50 N/mm² or less, the split-off of the film can be reduced.

The ambient temperature on application of the tension in the width direction of the film is preferably 20° C. or more and 170° C. or less, more preferably 25° C. or more and 160° C. or less, and further preferably 25° C. or more and 150° C. or less. When the ambient temperature on application of the tension is 20° C. or more, the split-off of the film can be reduced. When the ambient temperature is 170° C. or less, a sufficient width shrinkage can be imparted to the film.

### (Porosity of Polyolefin Resin Porous Film)

In the present invention, the porosity of the polyolefin resin porous film is preferably 30% or more and 50% or less. When the porosity is 30% or more, an effect of exhibiting favorable permeability can be provided, and when the porosity is 50% or less, an effect of retaining insulating property against high voltage can be provided. The porosity is more preferably 35% or more and 45% or less, and further preferably 38% or more and 42% or less.

The porosity of the polyolefin resin porous film may be measured in the method described in the examples later.

The thickness (T_{PO}) of the polyolefin resin porous film is preferably from 5 to 100 μm, more preferably from 8 to 50 μm, and further preferably from 10 to 30 μm. When the thickness of the polyolefin resin porous film is 5 μm or more, electric insulating property that is substantially required in the case where the laminated porous film of the present invention is used as a separator for a non-aqueous electrolyte secondary cell can be provided, and even in the case where a large force is applied, for example, to a protruding portion of the electrode, the separator can be prevented from being broken by penetration thereof, resulting in excellent safety. When the thickness of the polyolefin resin porous film is 100 μm or less, the electric resistance in the case where the laminated porous film of the present invention is used as a separator for a non-aqueous electrolyte secondary cell can be reduced, and thereby the performance of the cell can be sufficiently ensured.

The properties of the polyolefin resin porous film used in the present invention can be freely controlled by the layer structure, the lamination structure, the compositions of the layers, and the production method.

### (Production Method of Polyolefin Resin Porous Film)

For the production method of the polyolefin resin porous film, any of the known production methods of a porous film may be favorably employed with no particular limitation, and in general, such a method may be preferably employed that a nonporous film material as a precursor for forming the polyolefin resin porous film is produced, and the precursor is processed to have pores, thereby providing the polyolefin resin porous film.

The production method of the nonporous film material as a precursor for forming the polyolefin resin porous film is not particularly limited and may be any of the known methods, and examples thereof include such a method that a thermoplastic resin composition is melted and extruded from a T-die with an extruder, and then solidified by cooling with a cast roll. Such a method may also be applied that a film material produced by a tubular method is cut and opened into a flat shape.

The method of processing the nonporous film material to have pores is not particularly limited, and may be any of the known methods, such as pore formation by dry uniaxial or higher multiaxial stretching and pore formation by wet uniaxial or higher multiaxial stretching. Examples of the stretching method include a roll stretching method, a rolling method, a tenter stretching method, a simultaneous biaxial stretching method, and an inflation method, and these methods may be used solely or as a combination of two or more thereof for performing uniaxial or higher multiaxial stretching. Such a method may also be applied depending on necessity that a plasticizer contained in the polyolefin resin composition is extracted with a solvent and dried before and after stretching. A heat treatment and a relaxation treatment may be performed for the purpose of enhancing the dimensional stability.

The surface of the polyolefin resin porous film is preferably subjected to a surface treatment, such as a corona treatment, a plasma treatment, and a chemical oxidation treatment, for the purpose of enhancing the interlayer adhesion to the porous coating layer described later.

The method of providing a three-layer structure of porous layer A/porous layer B/porous layer A laminated and a four-layer structure or a higher multilayer structure may be roughly classified into the following three methods depending on the order of the pore formation and the lamination, and the like, and any of the methods may be employed in the present invention.

(i) A method of forming pores for the layers, and laminating or adhering the resulting porous layers using an adhesive or the like, so as to provide a laminated film.

(ii) A method of laminating the layers to provide a laminated nonporous film material, and then forming pores in the nonporous film material.

(iii) A method of forming pores in any one of the layers, laminating with another nonporous film material, and then forming pores therein.

### <Porous Coating Layer>

The laminated porous film of the present invention has a porous coating layer containing inorganic particles and a binder resin composition provided at least one surface of the front surface and the back surface of the polyolefin resin porous film asymmetrically on front and back surfaces.

The term “asymmetrically on front and back surfaces” herein includes the case where the porous coating layer is provided on only one surface of the polyolefin resin porous film. In the case where the porous coating layers are provided on both the surfaces of the polyolefin resin porous film, the term means that the average thickness of the porous coating layer on one surface and the average thickness of the porous coating layer on the other surface are different from each other.

The measurement and calculation method for the average thickness of the porous coating layer is as described in the examples later.

### (Inorganic Particles)

Examples of the inorganic particles that can be used in the present invention include a metallic carbonate, such as calcium carbonate, magnesium carbonate, and barium carbonate; a metallic sulfate, such as calcium sulfate, magnesium sulfate, and barium sulfate; a metallic fluoride, such as calcium fluoride and magnesium fluoride; a metallic hydroxide, such as aluminum hydroxide and magnesium hydroxide; a metallic oxide, such as alumina, calcia, magnesia, titania, zinc oxide, and silica; a clay mineral, such as talc, clay, and mica; and barium titanate. Among these, barium sulfate and alumina are preferably contained from the standpoint of the chemical inertness on installing in a battery cell.

The lower limit of the average particle diameter of the inorganic particles is preferably 0.01 μm or more, more preferably 0.1 μm or more, and further preferably 0.2 μm or more, and the upper limit thereof is preferably 3.0 μm or less, and more preferably 1.5 μm or less. When the average particle diameter is 0.01 μm or more, the laminated porous film of the present invention can exhibit sufficient heat resistance. When the average particle diameter is 3.0 μm or less, the dispersibility of the inorganic particles in the porous coating layer and a coating liquid may be enhanced.

The average particle diameter of the inorganic particles can be measured and calculated by a method using an image analyzer, a method using a laser diffraction particle size distribution measuring device, and the like. The average particle diameter in the case where an image analyzer is used can be calculated by averaging an average value of a minor diameter and a major diameter of a two-dimensional projected image obtained by projecting the inorganic particle in an arbitrary direction (which is designated as a direction Z) and an average value of a minor diameter and a major diameter of a two-dimensional projected image obtained by projecting the inorganic particle in an arbitrary direction (which is designated as a direction X) that is perpendicular to the direction Z. The number of the inorganic particles used for the calculation suffices to be 50 or more.

The specific surface area of the inorganic particles is preferably 5 m²/g or more and less than 15 m²/g. When the specific surface area is 5 m²/g or more, the laminated porous film of the present invention installed as a separator in a non-aqueous electrolyte secondary cell can facilitate penetration of the electrolyte, providing favorable productivity. When the specific surface area is less than 15 m²/g, the laminated porous film of the present invention installed as a separator in a non-aqueous electrolyte secondary cell can suppress adsorption of the components of the electrolyte.

The specific surface area of the inorganic particles may be measured by a constant volume gas adsorption method.

In the porous coating layer, the content of the inorganic particles based on the total amount of the inorganic particles and the binder resin composition is preferably 80% by mass or more and 99% by mass or less. The content of the inorganic particles is more preferably 92% by mass or more, further preferably 95% by mass or more, and particularly preferably 98% by mass or more. When the content of the inorganic particles is in the range, the porous coating layer can retain excellent gas permeability, and the heat resistance as the laminated porous film can be enhanced while retaining the adhesion between the polyolefin resin porous film and the porous coating layer.

### (Binder Resin Composition)

It is preferred that the binder resin composition can favorably adhere the inorganic particles and the polyolefin resin porous film, is electrochemically stable, and is stable to an organic electrolyte in the case where the laminated porous film is used as a separator for a non-aqueous electrolyte secondary cell.

Specific examples of the binder resin as a major component of the binder resin composition include a (meth)acrylic acid derivative, such as polyacrylic acid, poly-2-hydroxyethyl acrylate, poly-2-hydroxyethyl methacrylate, and polyacrylamide; a cellulose derivative, such as hydroxyethyl cellulose and carboxymethyl cellulose; a polyvinyl alcohol derivative, such as polyvinyl alcohol, polyvinyl formal, and polyvinyl butyral; a polyvinylamide derivative, such as polyvinylpyrrolidone and polyvinylacetamide; a polyether derivative, such as polyethylene oxide and polypropylene oxide; a polyamide resin, such as an aliphatic polyamide, an aromatic polyamide, and an aromatic-aliphatic polyamide; and copolymers thereof. Among these, carboxymethyl cellulose and polyvinyl alcohol are particularly preferred since high stability to an organic electrolyte can be obtained.

### (Modifier)

In the present invention, the binder resin composition may contain a modifier, such as a surfactant, a stabilizer, a curing agent, and a plasticizer.

### (Acid Component)

In the case where the porous coating layer in the present invention is formed on at least one surface of the polyolefin resin porous film in such a method that a dispersion liquid for forming the porous coating layer containing the inorganic particles and the binder resin dissolved or dispersed in a solvent is coated and dried thereon (i.e., a coating and drying method), the dispersion liquid preferably contains an acid component. The acid component contained may suppress aggregation of the inorganic particles in the dispersion liquid to enhance the viscosity stability of the dispersion liquid in long-term storage, and thereby the uniform porous coating layer can be provided.

In the laminated porous film of the present invention, the acid component may remain as an acid in the porous coating layer, or may remain as a salt formed through reaction with an alkaline impurity in the porous coating layer.

The first acid dissociation constant (pKₐ₁) of the acid component in a diluted aqueous solution at 25° C. is preferably 5 or less, and the second acid dissociation constant (pKₐ₂) thereof is preferably not present or 7 or more. Examples of the acid component having the characteristics include a lower primary carboxylic acid, such as formic acid, acetic acid, propionic acid, and acrylic acid; a nitro acid, such as nitric acid and nitrous acid; a halogen oxoacid, such as perchloric acid and hypochlorous acid; a halide ion, such as hydrochloric acid, hydrofluoric acid, and hydrobromic acid; phosphoric acid, salicylic acid, glycolic acid, lactic acid, ascorbic acid, and erythorbic acid. Among those, formic acid, acetic acid, nitric acid, hydrochloric acid, and phosphoric acid are preferred from the standpoint of the capability of decreasing the pH with a small amount added, the availability, and the high stability of the acid. The acid component that satisfies the aforementioned conditions may suppress aggregation of the inorganic particles, and the viscosity stability of the dispersion liquid for forming the porous coating layer used for forming the porous coating layer may be enhanced in long-term storage.

The dispersion liquid for forming the porous coating layer preferably contains the acid component in an amount in a range of 10 ppm by mass or more and 10,000 ppm by mass or less. The content of the acid component is more preferably 30 ppm by mass or more and 9,000 ppm by mass or less, and further preferably 50 ppm by mass or more and 8,000 ppm by mass or less.

When the content of the acid component in the dispersion liquid for forming the porous coating layer is 10 ppm by mass or more, the dispersion liquid that is excellent in viscosity stability in long-term storage can be obtained, and the uniform porous coating layer can be provided. When the content of the acid component is 10,000 ppm by mass or less, the non-aqueous electrolyte secondary cell using the laminated porous film having the porous coating layer as a separator may not be adversely affected by the acid component.

### (Production Method of Porous Coating Layer)

Examples of the formation method of the porous coating layer in the laminated porous film of the present invention include a coextrusion method, a lamination method, and a coating and drying method, and in view of the continuous productivity, the porous coating film is preferably formed in such a manner that a dispersion liquid for forming the porous coating layer containing the inorganic particles and the binder resin dissolved or dispersed in a solvent is coated and dried on at least one surface of the polyolefin resin porous film.

In the case where the porous coating layer is formed by the coating and drying method, the solvent of the dispersion liquid for forming the porous coating layer is preferably such a solvent that appropriately and uniformly disperses the inorganic particles stably and can appropriately and uniformly dissolve or disperse the binder resin stably.

Examples of the solvent include N-methylpyrrolidone, N,N-dimethylformamide, N,N-dimethylacetamide, dimethylsulfoxide, water, dioxane, acetonitrile, an alcohol having from 1 to 4 carbon atoms, a glycol compound, glycerin, and a lactate. Preferred examples of the alcohol having from 1 to 4 carbon atoms include a monohydric alcohol having from 1 to 4 carbon atoms, and one or more selected from methanol, ethanol, and isopropyl alcohol is more preferred. In the case where water is used as the solvent in the present invention, the content of water in the solvent is preferably 50% by mass or more, more preferably 70% by mass or more, further preferably 80% by mass or more, and still further preferably 90% by mass or more, from the standpoint of enhancing the viscosity stability of the coating liquid.

Among the solvents, water and a mixed solvent of water and an alcohol having from 1 to 4 carbon atoms are preferred, a mixed solvent of water and a monohydric alcohol having from 1 to 4 carbon atoms is more preferred, and a mixed solvent of water and isopropyl alcohol is further preferred, from the standpoint of the cost and the environmental load.

Examples of the method of dispersing the inorganic particles in the solvent include a mechanical stirring method using a ball mill, a bead mill, a planetary ball mill, a vibration ball mill, a sand mill, a colloid mill, an attritor, a roll mill, a high-speed dispersion impeller, a disperser, a homogenizer, a high-speed impact mill, an ultrasonic disperser, a stirring blade, or the like. The binder resin may also be dissolved or dispersed simultaneously with the dispersion of the inorganic particles.

In the production of the dispersion liquid for forming the porous coating layer by dispersing the inorganic particles and the binder resin in the solvent, a dispersion assistant, a stabilizer, a thickener, and the like may be further blended therein for enhancing the dispersion stability of the dispersion liquid for forming the porous coating layer and optimizing the viscosity suitable for forming the porous coating layer.

The process step of coating the dispersion liquid for forming the porous coating layer on the surface of the polyolefin resin porous film may be performed in the course of the production process of the polyolefin resin porous film used. For example, the process step may be performed after the extrusion molding step and before the stretching step of the polyolefin resin film, and may be performed after the stretching step. It is particularly preferred to coat after the stretching step, from the standpoint of the formation of the more uniform porous coating layer.

The coating method in the coating step is not particularly limited, as far as the method can achieve the necessary layer thickness and coated area. Examples of the coating method include a gravure coater method, a small-diameter gravure coater method, a reverse roll coater method, a transfer roll coater method, a kiss coater method, a dip coater method, a knife coater method, an air doctor coater method, a blade coater method, a rod coater method, a squeeze coater method, a cast coater method, a die coater method, a screen printing method, and a spray coating method.

In the present invention, a process step of removing the dispersion medium is preferably performed after coating the dispersion liquid for forming the porous coating layer. With the process step, the porous coating layer containing the inorganic particles and the binder resin composition can be formed on at least one surface of the polyolefin resin porous film. The method for removing the solvent is not particularly limited, as far as the method does not adversely affect the polyolefin resin porous film, and examples thereof include a method of drying at a temperature that is lower than the melting point of the polyolefin resin porous film while the polyolefin resin porous film is fixed, and a method of drying at a low temperature under reduced pressure.

In the case where a commercially available polyolefin resin porous film having a width shrinkage of less than 0.1% under a condition of 130° C. for 1 hour is used, the temperature on drying is preferably lower than the temperature, at which a tension is applied in the width direction of the polyolefin resin porous film, since the applied tension is difficult to relax.

The average thickness (T) of the porous coating layer in the laminated porous film of the present invention is preferably 0.5 μm or more, more preferably 1 μm or more, further preferably 2 μm or more, and particularly preferably 3 μm or more, from the standpoint of the heat resistance. The average thickness is preferably 20 μm or less, more preferably 15 μm or less, further preferably 10 μm or less, and particularly preferably 5 μm or less, from the standpoint of ensuring pore continuity for imparting excellent gas permeability characteristics. In the case where two or more layers of the porous coating layer are provided, the aforementioned average thickness means the thickness per one layer.

The average thickness of the porous coating layer can be calculated, for example, in such a manner that the measurement of the thickness of the porous coating layer from a vertical cross sectional image in the thickness direction of the laminated porous film of the present invention is repeated for cross sections at five random positions, and the arithmetic average value of the resulting values is obtained. In the case where the polyolefin resin porous film has the porous coating layer on only one surface thereof, the average thickness of the porous coating layer can be calculated, for example, as the difference between the total thickness of the laminated porous film after forming the porous coating layer and the total thickness of the polyolefin resin porous film, as described in the examples later.

In the case where the polyolefin resin porous film has the porous coating layers on both surfaces thereof, the average thickness of the porous coating layer laminated on the front surface and the average thickness of the porous coating layer laminated on the back surface are different from each other since the porous coating layers are provided asymmetrically on front and back surfaces.

In the present invention, the absolute value (T_{d}) of the difference in average thickness between the porous coating layers on the front and back surfaces is generally 1 μm or more. The value of T_{d} is preferably 20 μm or less from the standpoint of the handleability of the laminated porous film, and the like.

### [Shape and Properties of Laminated Porous Film]

The total thickness of the laminated porous film of the present invention may be appropriately selected depending on purposes. In the case where the laminated porous film is used as a separator for a non-aqueous electrolyte secondary cell, the total thickness of the laminated porous film is preferably from 5 to 100 μm, more preferably from 8 to 50 μm, and further preferably from 10 to 30 μm. When the total thickness is 5 μm or more, electric insulating property that is substantially required as a separator for a non-aqueous electrolyte secondary cell can be provided, and even in the case where a large force is applied, for example, to a protruding portion of the electrode, the separator can be prevented from being broken by penetration thereof, resulting in excellent safety. When the total thickness of the laminated porous film is 100 μm or less, the electric resistance of the laminated porous film can be reduced, and thereby the performance of the cell can be sufficiently ensured.

In the laminated porous film of the present invention, the ratio T_{d}/T_{PO} of the absolute value (T_{d}) of the difference in average thickness between the porous coating layers on the front and back surfaces to the thickness (T_{PO}) of the polyolefin resin porous film is preferably 0.1 or more and 0.5 or less. In the case where the laminated porous film of the present invention has the porous coating layer on only one surface thereof, the average thickness (T) of the porous coating layer is designated as the value T_{d}.

When the ratio T_{d}/T_{PO} is 0.1 or more, the laminated porous film of the present invention can be imparted with sufficient heat resistance. When the ratio T_{d}/T_{PO} is 0.5 or less, the porous coating layer can be suppressed from being cracked and released off.

In the laminated porous film of the present invention, the porosity is preferably 30% or more, more preferably 35% or more, and further preferably 40% or more. When the porosity is 30% or more, the pore continuity can be ensured to provide the laminated porous film excellent in gas permeability characteristics.

The porosity of the laminated porous film is preferably 70% or less, more preferably 65% or less, and further preferably 60% or less. When the porosity is 70% or less, the strength of the laminated porous film can be sufficiently retained, which is also favorable from the standpoint of the handleability.

The gas permeability of the laminated porous film of the present invention is preferably 1,000 sec/100 mL or less, more preferably from 10 to 800 sec/100 mL, and further preferably from 50 to 500 sec/100 mL. The gas permeability that is 1,000 sec/100 mL or less is preferred since the value means that the laminated porous film has pore continuity, showing an excellent gas permeation capability.

The gas permeability shows the easiness of air passing through the film in the thickness direction thereof, and specifically shows as a period of time that is required for passing 100 mL of air through the film. Accordingly, a smaller value thereof means easier in passing through, whereas a larger value thereof means more difficult in passing through. In other words, a smaller value thereof means better pore continuity of the pores in the thickness direction of the film, whereas a larger value thereof means poorer pore continuity of the pores in the thickness direction of the film. The pore continuity is an extent of connection of pores in the thickness direction of the film. The laminated porous film of the present invention that has a smaller gas permeability can be used in various applications. For example, in a case where the laminated porous film is used as a separator for a non-aqueous electrolyte secondary cell, a small gas permeability means that ions can easily migrate, and thus is preferred since an excellent battery cell performance can be obtained.

The laminated porous film of the present invention preferably has SD characteristics in the use thereof as a separator for a battery cell. Specifically, the gas permeability thereof after heating to 135° C. for 5 seconds is preferably 10,000 sec/i 00 mL or more, more preferably 25,000 sec/100 mL or more, and further preferably 50,000 sec/100 mL or more. When the gas permeability after heating to 135° C. for 5 seconds is 10,000 sec/100 mL or more, the pores are quickly closed in abnormal heat generation to shutdown the electric current, and thereby troubles of the battery cell, such as rupture thereof, can be avoided.

The melt in-plane shrinkage of the laminated porous film of the present invention is preferably less than 8%, more preferably less than 7%, and further preferably less than 6%. The melt in-plane shrinkage that is less than 8% suggests favorable dimensional stability and heat resistance even on abnormal heat generation beyond the SD temperature, whereby the breakage of the film can be prevented, and the internal short-circuit temperature can be increased.

The melt in-plane shrinkage of the laminated porous film may be measured in the method described in the examples later.

The laminated porous film of the present invention is excellent in adhesion between the polyolefin resin porous film and the porous coating layer. The adhesion of the porous coating layer can be evaluated by the peel strength measured by the method described in the examples later, and a larger peel strength shows a film having better smoothness.

The peel strength is preferably 3 N/18 mm or more from the standpoint of preventing troubles in conveyance of the film and appearance failures thereof, and is more preferably 4 N/18 mm or more. The upper limit thereof is not particularly limited, and is ideally 20 N/18 mm or less, and practically preferably 10 N/18 mm or less.

The laminated porous film of the present invention is a laminated porous film having reduced curl as described above, and it is important the laminated porous film has a maximum curl height in the width direction of 5 mm or less on standing the laminated porous film having a size of 15 cm square still on a stainless steel (SUS) plate under an atmosphere of a temperature of 25° C. and a relative humidity of 50% for 5 minutes, for exhibiting the effect of reducing the possibility of problems including folding wrinkles and fluttering in the case where the laminated porous film is wound into a roll product and in the case where the laminated porous film is wound with an electrode into a wound assembly for using the film as a separator for a cylindrical battery cell.

The maximum curl height in the width direction of the laminated porous film is preferably 4 mm or less, more preferably 3 mm or less, further preferably 2 mm or less, still further preferably 1 mm or less, and ideally 0 mm.

The maximum curl height in the width direction of the laminated porous film may be measured under the aforementioned condition by the method described in the examples later.

### [Non-Aqueous Electrolyte Secondary Cell]

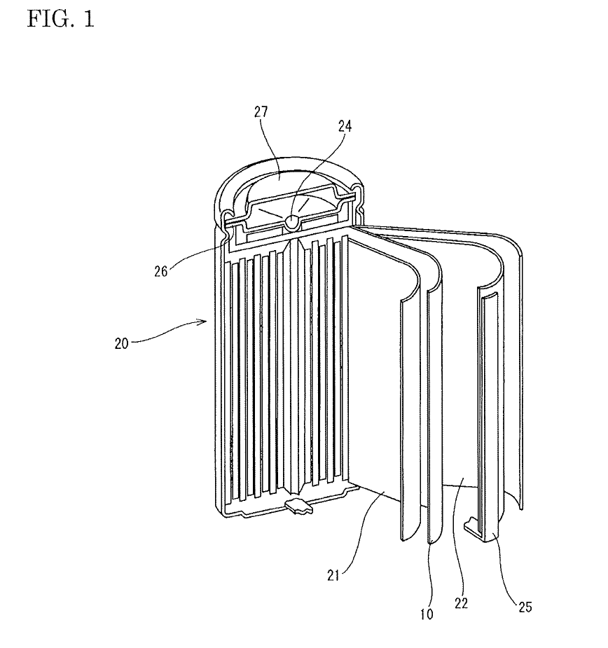

Subsequently, a non-aqueous electrolyte secondary cell 20 having housed therein the laminated porous film of the present invention as a separator for a non-aqueous electrolyte secondary cell will be described with reference to FIG. 1. The present invention is not limited to the non-aqueous electrolyte secondary cell 20.

Both electrodes, i.e., a positive electrode sheet 21 and a negative electrode sheet 22, are spirally wound to be layered on each other with a separator 10 for a battery cell intervening therebetween, and the outer periphery thereof is fastened with a winding stopper tape to provide a wound assembly.

The winding process will be described in detail. One end of the separator for a battery cell is led to pass through a slit part of a pin, and the pin is slightly rotated to wind the end of the separator for a battery cell around the pin. At this time, the surface of the pin is in contact with the porous coating layer of the separator for a battery cell. Thereafter, a positive electrode and a negative electrode are disposed to hold the separator for a battery cell therebetween, and the pin is rotated with a winding device to wind the positive and negative electrodes and the separator for a battery cell. After winding, the pin is drawn off from the wound assembly.

The wound assembly having the positive electrode sheet 21, the separator 10 for a battery cell, and the negative electrode sheet 22 having been integrally wound is housed in a bottomed cylindrical battery case, and welded to positive electrode and negative electrode leads 24 and 25. An electrolyte is then charged into the battery canister, and after the electrolyte has sufficiently penetrated into the separator 10 for a battery cell and the like, the opening of the battery canister is sealed with a positive electrode cap 27 fitted to the peripheral edge of the opening via a gasket 26. The battery cell is then pre-charged and aged to produce a cylindrical non-aqueous electrolyte secondary cell 20.

The electrolyte used may contain a lithium salt as an electrolyte dissolved in an organic solvent. The organic solvent is not specifically limited, and examples thereof include an ester compound, such as propylene carbonate, ethylene carbonate, butylene carbonate, γ-butyrolactone, γ-valerolactone, dimethyl carbonate, methyl propionate, and butyl acetate; a nitrile compound, such as acetonitrile; an ether compound, such as 1,2-dimethoxyethane, 1,2-dimethoxymethane, dimethoxypropane, 1,3-dioxolan, tetrahydrofuran, 2-methyltetrahydrofuran, and 4-methyl-1,3-dioxolane; and sulfolane, which may be used solely or as a mixture of two or more kinds thereof.

The negative electrode used may be an electrode obtained by integrating a compound containing an alkali metal or an alkali metal-containing compound with a collector material, such as a stainless steel mesh. Examples of the alkali metal include lithium, sodium, and potassium. Examples of the alkali metal-containing compound include an alloy of an alkali metal with aluminum, lead, indium, potassium, cadmium, tin, or magnesium; a compound of an alkali metal and a carbonaceous material; and a compound of a low-potential alkali metal and a metallic oxide or sulfide. In the case where a carbonaceous material is used in the negative electrode, the carbonaceous material suffices to be capable of being doped and dedoped with lithium ion, and examples thereof used include graphite, pyrolytic carbon, cokes, glassy carbon, a baked material of an organic polymer compound, mesocarbon microbeads, carbon fibers, and activated carbon.

Examples of the active substance used for the positive electrode includes a metallic oxide, such as lithium cobalt oxide, lithium nickel oxide, lithium manganese oxide, manganese dioxide, vanadium pentoxide, and chromium oxide, and a metallic sulfide, such as molybdenum disulfide, and a composition containing the active substance having a conductive assistant and a binder, such as polytetrafluoroethylene, added appropriately thereto may be formed into a molded article with a collector material, such as a stainless steel mesh, as a core and used as the positive electrode.

### EXAMPLES

The laminated porous film of the present invention will be described in more detail with reference to Examples and Comparative Examples shown below, but the present invention is not limited thereto.

### <Evaluation Methods>

### (1) Width Shrinkage of Polyolefin Resin Porous Film

The porous coating layer of the laminated porous film was removed by wiping off the porous coating layer with a medium (such as water and an alcohol) that did not swell or dissolve the polyolefin resin porous film, and the film was dried in vacuum at ordinary temperature to provide the polyolefin resin porous film. The film was cut into a strip with a size of 20 cm in the width direction and 1 cm in the running direction and subjected to a heat treatment by standing still in an oven at 130° C. for 1 hour, and then the dimensional decrement in the width direction after the treatment was measured and divided by the dimension before the treatment, so as to calculate the width shrinkage of the polyolefin resin porous film.

### (2) Porosity of Polyolefin Resin Porous Film

The porous coating layer of the laminated porous film was removed by wiping off the porous coating layer with a medium (such as water and an alcohol) that did not swell or dissolve the polyolefin resin porous film, and the film was dried in vacuum at ordinary temperature to provide the polyolefin resin porous film. The film was cut into a size of 50 mm×50 mm and measured for the mass thereof with a balance and for the thickness with a dial gage, and the porosity was calculated by the following expression.

Porosity (%)=100−{W₁/(50×50×T_{PO}×R/1000)×100}

W₁: Mass of polyolefin resin porous film (g)

T_{PO}: Thickness of polyolefin resin porous film (mm)

R: True density of polyolefin resin porous film (g/cm³)

### (3) Thickness of Polyolefin Resin Porous Film and Total Thickness of Laminated Porous Film

The thickness of the polyolefin resin porous film and the total thickness of the laminated porous film each were calculated in such a manner that the thickness was measured with a 1/1000 mm dial gage at random five positions within the film plane, and the average value thereof was used.

### (4) Average Thickness of Porous Coating Layer

The average thickness of the porous coating layer was calculated as the difference between the total thickness of the laminated porous film after forming the porous coating layer and the total thickness of the polyolefin resin porous film.

### (5) Gas Permeability (Gurley Value)

The gas permeability was measured according to JIS P8117 (2009).

(6) Melt in-Plane Shrinkage

Waterproof abrasive paper #1000 (produced by Riken Corundum Co., Ltd.) cut into a size of 115 mm×140 mm was placed on a hot plate (ND-2, produced by AS ONE Corporation) set to 40° C. with the abrasive surface directed upward, the laminated porous film cut into a square of 100 mm×100 mm was superimposed thereon, a polyethylene terephthalate (PET) film (Diafoil T100-38, produced by Mitsubishi Plastics, Inc.) cut into a square of 200 mm×200 mm having been subjected to a heat treatment at 180° C. for 1 hour was further superimposed thereon, two sheets of heat resistant glass (Toshin Riko Co., Ltd.) with a size of 200 mm×200 mm×5 mm were superimposed thereon, the temperature of the hot plate was set at 200° C., after reaching 200° C. was decreased to 40° C., and then the specimen was taken out.

A PET film (Diafoil T100-38, produced by Mitsubishi Plastics, Inc.) cut into a square of 100 mm×100 mm was measured for the weight (which was represented by W₂) and superimposed on the specimen, the shape of the shrunk specimen was transcribed, and the PET film was cut and measured for the weight (which was represented by W₃). The melt in-plane shrinkage was calculated by the following expression.

Melt in-plane shrinkage (%)=[1−(W₃/W₂)}×100

### (7) Heat Resistance

The heat resistance was evaluated by the following evaluation standard.

A: Melt in-plane shrinkage of less than 8%

B: Melt in-plane shrinkage of 8% or more

### (8) Peel Strength

The laminated porous film produced was measured for the peel strength between the polyolefin resin porous film and the porous coating layer, according to JIS Z0237 (2009).

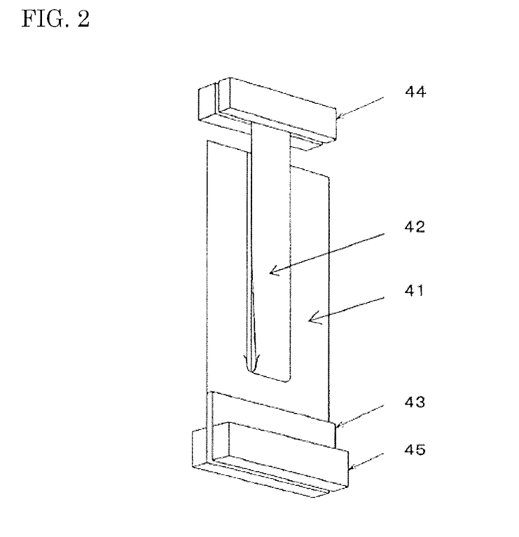

The laminated porous film was cut into a strip with a size of 150 mm in the running direction and 50 mm in the width direction and designated as a specimen 41, and a cellophane adhesive tape (produced by Nichiban Co., Ltd., width: 18 mm) as an adhesive tape 42 (FIG. 2) was adhered to the specimen in the longitudinal direction, folded by 180° in such a manner that the surface thereof opposite to the adhesive surface was superimposed on each other, and peeled off from the specimen by 25 mm.

Subsequently, one end of the specimen in the region where the tape had been peeled off was fixed to a lower chuck 45 of a tensile tester (Intesco IM-20ST, produced by Intesco Co., Ltd.), the cellophane adhesive tape was fixed to an upper chuck 44 thereof, and the peel strength was measured at a test speed of 300 mm/min (FIG. 2). After the measurement, the measured values for the initial 25 mm length was ignored, and the measured peel strength values for a length of 50 mm peeled from the test piece were averaged and designated as the peel strength.

### (9) Adhesion

The adhesion was evaluated by the following evaluation standard.

A: Peel strength of 3 N/18 mm or more

B: Peel strength of less than 3 N/18 mm

### (10) Maximum Curl Height in Width Direction

The laminated porous film produced was cut into two sheets each with a size of 15 cm×15 cm, the sheets were placed sheet by sheet on a stainless steel (SUS) plate in such a manner that the porous coating layers were directed upward and downward respectively, and allowed to stand under an atmosphere of a temperature of 25° C. and a relative humidity of 50% for 5 minutes, the height in the vertical direction of the film floating from the horizontal surface of the SUS plate was measured with a ruler at the both end edges in the running direction of the film over the entire width, and the maximum value thereof was designated as the maximum curl height in the width direction. In the case where the film was curled into a cylindrical shape, the maximum diameter of the cylinder was designated as the maximum curl height.

### (11) Curl Resistance

Based on the numerals of the maximum curl height measured in the item (10), the curl resistance was evaluated by the following evaluation standard.

A: The maximum curl height in the width direction of the laminated porous film was 5 mm or less in both the cases where the porous coating layer was directed upward and downward.

B: The maximum curl height in the width direction of the laminated porous film exceeded 5 mm in any one of the cases where the porous coating layer was directed upward and downward.

### (12) SD Characteristics

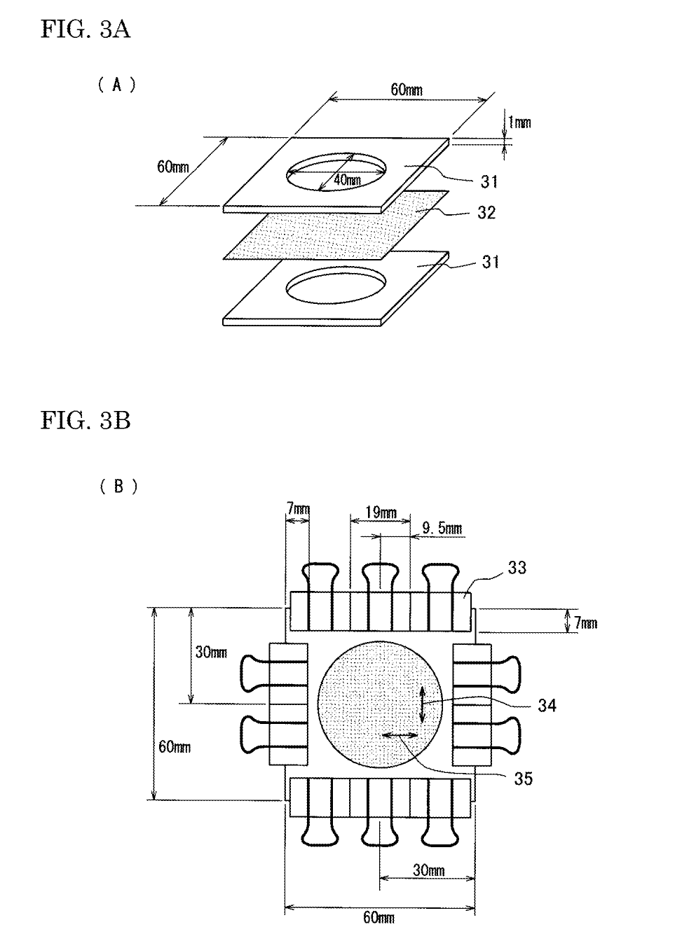

The polyolefin resin porous film was cut into a square of 60 mm×60 mm to provide a specimen 32, which was held between two aluminum plates 31 (material: JIS A5052, size: 60 mm in length, 60 mm in width, and 1 mm in thickness) each having a circular hole having a diameter of 40 mm at the center thereof as shown in FIG. 3(A), and the periphery thereof was fixed with clips 33 as shown in FIG. 3(B). Subsequently, an oil bath (OB-200A, produced by AS ONE Corporation) was filled with glycerin (produced by Nacalai Tesque, Inc., first class grade) at 135° C. to a height of 100 mm from the bottom, and the film fixed with the two aluminum plates was immersed therein at the center of the oil bath for heating for 5 seconds. Immediately after heating, the film was immersed in a cooling bath filled with glycerin at 25° C., which had been separately prepared, for cooling for 5 minutes, rinsed with 2-propanol (produced by Nacalai Tesque, Inc., special grade) and acetone (produced by Nacalai Tesque, Inc., special grade), and dried in an air environment at 25° C. for 15 minutes. The circular portion having a diameter of 40 mm of the dried film at the center thereof was measured for the gas permeability according to the method described in the item (5) above.

The SD characteristics of the laminated porous film was evaluated based on the gas permeability of the polyolefin resin porous film by the following evaluation standard.

A: Gas permeability of 10,000 sec/i 00 mL or more providing SD characteristics

B: Gas permeability of less than 10,000 sec/100 mL providing no SD characteristics

### (Polyolefin Resin Porous Film)

Polyolefin resin porous film 1: A porous film having a porous layer A containing a polypropylene resin as a major component and a porous layer B containing a polyethylene resin as a major component, having a two-kind and three-layer structure of A/B/A, thickness: 20 μm, gas permeability: 530 sec/100 mL, gas permeability after heating to 135° C. for 5 seconds: 99,999 sec/100 mL, width shrinkage: 0.0%, porosity: 39%

Polyolefin resin porous film 2: A porous film having a porous layer A containing a polypropylene resin as a major component and a porous layer B containing a polyethylene resin as a major component, having a two-kind and three-layer structure of A/B/A, thickness: 16 μm, gas permeability: 470 sec/100 mL, gas permeability after heating to 135° C. for 5 seconds: 99,999 sec/100 mL, width shrinkage: 0.0%, porosity: 39%

Polyolefin resin porous film 3: A porous film having a single layer structure containing a polypropylene resin as a major component, thickness: 20 μm, gas permeability: 160 sec/100 mL, gas permeability after heating to 135° C. for 5 seconds: 170 sec/100 mL, width shrinkage: 1.3%, porosity: 55%

The polyolefin resin porous films 1 to 3 each were subjected to a corona surface treatment on one surface thereof with a corona treatment equipment (Generator CPI, produced by Vetaphone A/S) under a condition of an output power of 0.4 kW and a speed of 10 m/min.

### (Production of Dispersion Liquid for Forming Porous Coating Layer)

52.6 parts by mass of alumina (LS-410, produced by Nippon Light Metal Co., Ltd.), 5.3 parts by mass of isopropyl alcohol, and 42.1 parts by mass of ion exchanged water were mixed and treated with a bead mill, so as to provide an alumina slurry. The condition for the bead mill used was as follows.

Equipment: NVM-1.5, produced by Aimex Co., Ltd.)

Beads: zirconia, diameter: 0.5 mm, filling rate: 85%

Circumferential velocity: 10 m/sec

Discharge rate: 350 mL/min

After allowing to stand the resulting alumina slurry for one week, 62 parts by mass of the alumina slurry, 10 parts by mass of a 5% by mass polyvinyl alcohol (PVA-124, produced by Kuraray Co., Ltd.) aqueous solution, and 28 parts by mass of ion exchanged water were mixed, to which hydrochloric acid was added to make a concentration of 70 ppm by mass based on the total amount thereof, thereby providing a dispersion liquid for forming a porous coating layer having a solid content concentration of 33% by mass.

### Example 1

The polyolefin resin porous film 1 was cut into a rectangular shape with a size of 20 cm in the running direction and 40 cm in the width direction, to which a tension of 4.8 N was uniformly applied in the width direction under an atmosphere of a temperature of 25° C., and subsequently the resulting dispersion liquid was coated on the corona-treated surface with a bar coater #12, and then dried under an atmosphere of a temperature of 25° C. and a relative humidity of 50% for 20 minutes.

After drying, the resulting laminated porous film was relieved from the tension, and evaluated for the properties thereof. The results are shown in Table 1. The width shrinkage of the polyolefin resin porous film 1 was 0.2%.

### Example 2

The polyolefin resin porous film 2 was cut into a rectangular shape with a size of 20 cm in the running direction and 40 cm in the width direction, to which a tension of 4.8 N was uniformly applied in the width direction under an atmosphere of a temperature of 25° C., and subsequently the resulting dispersion liquid was coated on the corona-treated surface with a bar coater #12, and then dried under an atmosphere of a temperature of 25° C. and a relative humidity of 50% for 20 minutes.

After drying, the resulting laminated porous film was relieved from the tension, and evaluated for the properties thereof. The results are shown in Table 1. The width shrinkage of the polyolefin resin porous film 2 was 0.2%.

### Comparative Example 1

The polyolefin resin porous film 1 was cut into a rectangular shape with a size of 20 cm in the running direction and 40 cm in the width direction, to which a tension of 4.8 N was uniformly applied in the width direction under an atmosphere of a temperature of 25° C., and subsequently the resulting dispersion liquid was coated on the corona-treated surface with a bar coater #12, and then dried with a dryer at a temperature of 80° C. for 2 minutes.

After drying, the resulting laminated porous film was relieved from the tension applied thereto, and evaluated for the properties thereof. The results are shown in Table 1. The width shrinkage of the polyolefin resin porous film 1 was 0.0%.

### Comparative Example 2

The polyolefin resin porous film 1 was cut into a rectangular shape with a size of 20 cm in the running direction and 40 cm in the width direction, to which a tension of 2.4 N was uniformly applied in the running direction under an atmosphere of a temperature of 25° C., and subsequently the resulting dispersion liquid was coated on the corona-treated surface with a bar coater #12, and then dried under an atmosphere of a temperature of 25° C. and a relative humidity of 50% for 20 minutes.

After drying, the resulting laminated porous film was relieved from the tension, and evaluated for the properties thereof. The results are shown in Table 1. The width shrinkage of the polyolefin resin porous film 1 was −0.1%.

### Comparative Example 31

The polyolefin resin porous film 3 was cut into a rectangular shape with a size of 20 cm in the running direction and 40 cm in the width direction, to which a tension of 2.4 N was uniformly applied in the width direction under an atmosphere of a temperature of 25° C., and subsequently the resulting dispersion liquid was coated on the corona surface with a bar coater #12, and then dried under an atmosphere of a temperature of 25° C. and a relative humidity of 50% for 20 minutes.

After drying, the resulting laminated porous film was relieved from the tension, and evaluated for the properties thereof. The results are shown in Table 1. The width shrinkage of the polyolefin resin porous film 3 was 13.9%.

### Comparative Example 4

In Comparative Example 4, no porous coating layer was laminated, but the polyolefin resin porous film 1 was evaluated for the properties thereof. The results are shown in Table 1.

TABLE 1

| | | Example | | Comparative Example | | | |
|---|---|---|---|---|---|---|---|
| | | 1 | 2 | 1 | 2 | 3 | 4 |
| Width shrinkage | % | 0.2 | 0.2 | 0.0 | −0.1 | 13.9 | 0.0 |
| of polyolefin | | | | | | | |
| resin porous film | | | | | | | |
| Porosity of | % | 39 | 39 | 39 | 39 | 55 | 39 |
| polyolefin resin | | | | | | | |
| porous film | | | | | | | |
| Total thickness | μm | 25 | 20 | 25 | 25 | 25 | 20 |
| of laminated | | | | | | | |
| porous film | | | | | | | |
| Thickness of | μm | 5 | 4 | 5 | 5 | 5 | — |
| coating layer | | | | | | | |
| Gas permeability | sec/100 | 580 | 510 | 570 | 590 | 200 | 530 |
| | mL | | | | | | |
| Melt in-plane | % | 3.8 | 3.2 | 3.3 | 3.9 | 20.7 | 9.5 |
| shrinkage | | | | | | | |
| Heat resistance | — | A | A | A | A | B | B |
| Peel strength | N/18 mm | 5.4 | 5.3 | 5.2 | 5.3 | 4.8 | — |
| Adhesion | — | A | A | A | A | A | — |
| Maximum curl | mm | 1.8 | 1.5 | 25.2 | 24.8 | 2.6 | 0.0 |
| height in width | | | | | | | |
| direction | | | | | | | |
| Curl resistance | — | A | A | B | B | A | A |
| SD | — | A | A | A | A | B | A |
| characteristics | | | | | | | |

As apparent from Table 1, the laminated porous films obtained in Examples each had the width shrinkage of the polyolefin resin porous film that was in the prescribed range, had a small curl of the laminated porous film provided with the porous coating layer, and had favorable heat resistance, gas permeability, adhesion of the porous coating layer, and SD characteristics.

On the other hand, the laminated porous films obtained in Comparative Examples 1 and 2 each had the width shrinkage of the polyolefin resin porous film that was too small, and thus was curled in the width direction into a cylindrical shape, providing deteriorated curl resistance.

The laminated porous film obtained in Comparative Example 3 had the width shrinkage and the melt in-plane shrinkage of the polyolefin resin porous film that were too large, and thus had deteriorated heat resistance and no SD characteristics.

The polyolefin resin porous film obtained in Comparative Example 4 had no porous coating layer, and thus was insufficient in heat resistance.

### INDUSTRIAL APPLICABILITY

The laminated porous film of the present invention can be applied to various purposes that require gas permeability characteristics. Specifically, the laminated porous film can be extremely favorably used as a material for a separator for a lithium ion secondary cell; a hygienic material, such as a pad for body fluid absorption, such as a disposable diaper and a sanitary item, and a bed sheet; a medical supply material, such as a surgical gown and a hot pack substrate; a clothing material, such as a jacket, sportswear, and rainwear; a building material, such as a wallpaper, a roof waterproofing material, a heat insulating material, and an acoustic absorbent material; a desiccant; a moisture proof agent; a deoxidizer; a disposable pocket warmer; and a packaging material, such as a freshness-keeping packaging material and a food packaging material.

### REFERENCE SIGNS LIST

10 separator for non-aqueous electrolyte secondary cell
20 secondary cell
21 positive electrode sheet
22 negative electrode sheet
24 positive electrode lead
26 negative electrode lead
26 gasket
27 positive electrode cap
31 aluminum plate
32 specimen
33 clip
34 running direction of film
35 width direction of film
41 specimen
42 adhesive tape
43 non-slip member
44 upper chuck
45 lower chuck

1: A laminated porous film comprising a polyolefin resin porous film having a structure where porous layers A each containing a polyolefin resin having a melting point of 150° C. or more as a major component and a porous layer B containing a polyolefin resin as a major component and undergoing pore closure in a temperature range of 100° C. or more and less than 150° C. are laminated in an order of A/B/A, and having, laminated on at least one surface of the polyolefin resin porous film, a porous coating layer containing inorganic particles and a binder resin composition,
the porous coating layer being provided asymmetrically on front and back surfaces of the polyolefin resin porous film,
the polyolefin resin porous film having a width shrinkage of 0.1% or more and 3% or less in a heat treatment at a temperature of 130° C. for 1 hour,
a maximum curl height in a width direction of the laminated porous film being 5 mm or less on standing the laminated porous film having a size of 15 cm square still on a stainless steel (SUS) plate under an atmosphere of a temperature of 25° C. and a relative humidity of 50% for 5 minutes.

2: The laminated porous film according to claim 1, wherein a ratio T_{d}/T_{PO} of an absolute value (T_{d}) of a difference in average thickness between the porous coating layers on the front and back surfaces of the polyolefin resin porous film to a thickness (T_{PO}) of the polyolefin resin porous film is 0.1 or more and 0.5 or less.

3: The laminated porous film according to claim 1, wherein the porous layer A contains a polypropylene resin as a major component.

4: The laminated porous film according to claim 1, wherein the porous layer B contains a polyethylene resin as a major component.

5: The laminated porous film according to claim 1, wherein the polyolefin resin porous film has a porosity of 30% or more and 50% or less.

6: The laminated porous film according to claim 1, wherein the binder resin composition has an equilibrium water content of 1% or more.

7: The laminated porous film according to claim 1, which has a melt in-plane shrinkage of 8% or less.

8: A separator for a non-aqueous electrolyte secondary cell, comprising the laminated porous film according to claim 1.

9: A non-aqueous electrolyte secondary cell comprising the separator for a non-aqueous electrolyte secondary cell according to claim 8.

10: A method for producing a laminated porous film, comprising: applying a tension in a width direction to a polyolefin resin porous film which has a structure where porous layers A each containing a polyolefin resin having a melting point of 150° C. or more as a major component and a porous layer B containing a polyolefin resin as a major component and undergoing pore closure in a temperature range of 100° C. or more and less than 150° C. are in a structure of A/B/A and has a width shrinkage of less than 0.1% in a heat treatment at a temperature of 130° C. for 1 hour, so as to have a width shrinkage of 0.1% or more and 3% or less in a heat treatment at a temperature of 130° C. for 1 hour; and then forming a porous coating layer containing inorganic particles and a binder resin composition on at least one surface of the polyolefin resin porous film.
